(19) United States
(12) Patent Application Publication
(10) Pub. No.: US 2002/0094828 A1
(43) Pub. Date: Jul. 18, 2002

(54) Cordless telephone

(76) Inventor: Cantus Chin Chang Tang, Taipei (TW)

Correspondence Address: BACON & THOMAS, PLLC, 625 SLATERS LANE, FOURTH FLOOR, ALEXANDRIA, VA, 22314

(21) Appl. No.: 09/873,255

(22) Filed: Jun. 5, 2001

(30) Foreign Application Priority Data
Jan. 12, 2001 (TW) 090200671

(51) Int. Cl. H04Q 7/20

(52) U.S. Cl. 455/462; 455/550

(57) ABSTRACT

A cordless telephone is provided in which the height of handset is reduced to be substantially the same as that of keypad, resulting in a reduction of size and weight of handset thus enabling to be placed in a small space such as pocket of clothing for ease of calling in a hands-free manner; receiver is enclosed by and installed at a predetermined location of antenna; and transmitter is formed on the back of housing of handset opposite to keypad for prolonging the audio feedback path between receiver and transmitter, resulting in a substantially total elimination of audio feedback caused by the height reduction of handset.

### BACKGROUND OF THE INVENTION

1. Field of the Invention

The present invention relates to cordless telephones and more particularly to a cordless telephone with improved characteristics.

2. Description of Related Art

Cordless telephones have been widely used throughout the world. It provides convenience and mobility to people in a house while making or receiving a call. For example, a person may hold a handset to answer a call while walking to another position in the house. In a second case, person may use head and shoulder to clip handset around the neck while working. However, the prior art suffered from several disadvantages. For example, user may feel sore and stiff in the neck, shoulder, and head portions after long periods of time of using cordless telephone in the second case. Further, handset is relatively lengthy and bulky as compared to mobile phones. Thus, it is impossible to place handset in pocket of clothing, resulting in a limitation of the applicability of handset.

Thus, it is desirable to provide an improved cordless telephone in order to overcome the above drawbacks of prior art.

### SUMMARY OF THE INVENTION

It is an object of the present invention to provide a cordless telephone characterized in that the height of handset is reduced to be substantially the same as that of keypad, resulting in a reduction of size and weight of handset thus enabling to be placed in a small space such as pocket of clothing for ease of calling in a hands-free manner; receiver is enclosed by and installed at a predetermined location of antenna, preferably at the upper or middle part of antenna; and transmitter is formed on the back of housing of handset opposite to keypad for prolonging the audio feedback path between receiver and transmitter, resulting in a substantially total elimination of audio feedback caused by the height reduction of handset.

To achieve the above and other objects, the present invention provides a cordless telephone handset comprising a housing, a circuit in said housing, an antenna on said housing, a receiver, a keypad on said front side of said housing, and a transmitter on a predetermined position of said housing, characterized in that said receiver is mounted at a predetermined location within said antenna, prefer at an upper or middle portion of said antenna wherein said circuit comprises a high frequency modulation circuit for receiving signals from the antenna, a transmitter audio frequency amplification circuit for transmitting audio signals to the transmitter, a decoder, a micro processor control unit, an encoder and a receiver audio frequency amplification circuit for receiving audio signals from receiver.

The above and other objects, features and advantages of the present invention will become apparent from the following detailed description taken with the accompanying drawings.

### BRIEF DESCRIPTION OF THE DRAWINGS

FIG. 1 is a front plan view of a first preferred embodiment of handset according to the invention;

FIG. 2 is a rear plan view of FIG. 1;

FIG. 3 is a side view of FIG. 1;

FIG. 4 is a sectional view of a first preferred embodiment of antenna according to the invention;

FIG. 5 is a schematic block diagram of a first preferred embodiment of handset according to the invention;

FIG. 6 is a perspective view of a cordless telephone incorporating the FIG. 1 handset where handset is separated from telephone set;

FIG. 7 is a view similar to FIG. 6 where a second preferred embodiment of hand-free manner handset is illustrated;

FIG. 8 is a sectional view of a third preferred embodiment of antenna according to the invention; and

FIG. 9 is a schematic block diagram of a third preferred embodiment of handset according to the invention.

### DETAILED DESCRIPTION OF THE PREFERRED EMBODIMENTS

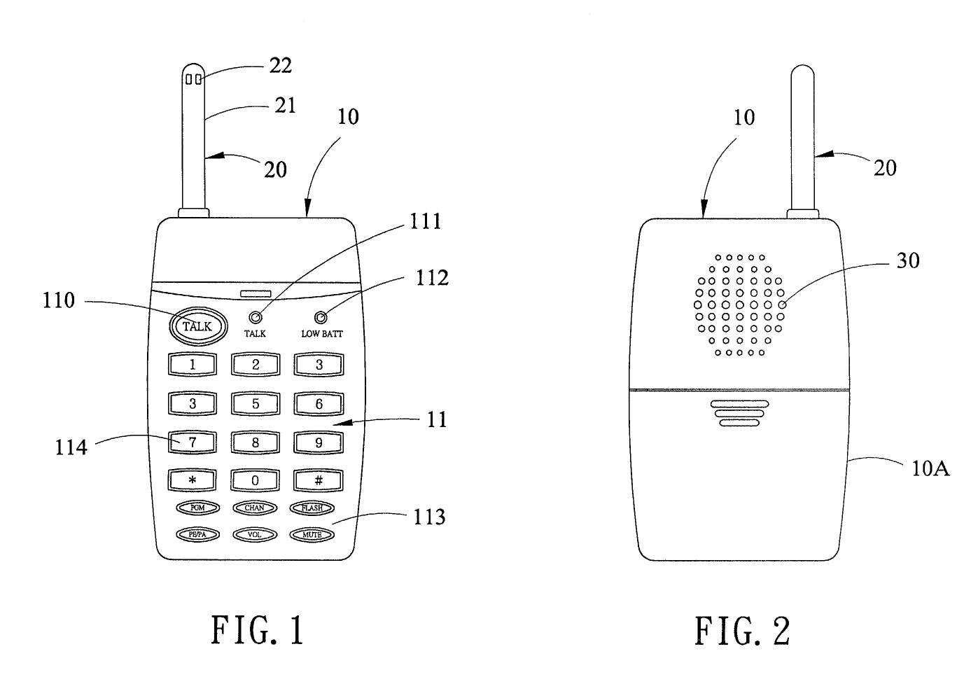

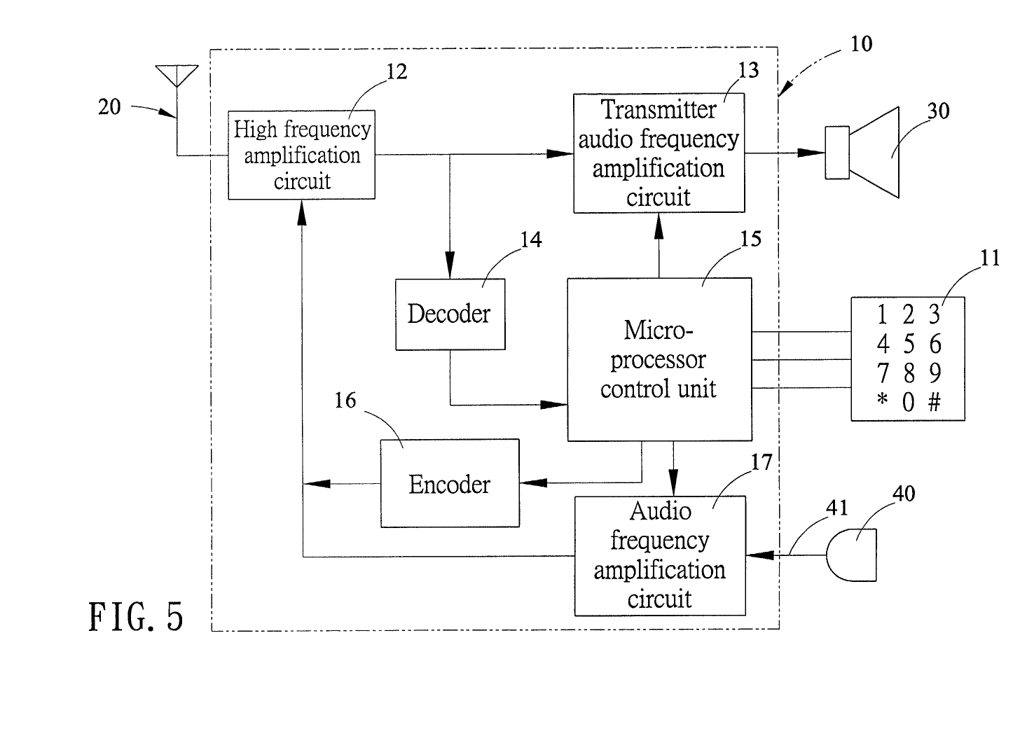

As shown in FIGS. 1-6, a handset 10 in accordance with the invention is mountable on a cordless telephone 100. Handset 10 comprises a housing 10A, an antenna housing 20 having a helical antenna 23 therein, a transmitter 30, and a receiver 40. On the front side of housing 10A, a plurality of components are formed such as a keypad 11 including alphanumeric keys 114(e.g., 0 to 9, *, and #), six function keys 13 below the alphanumeric keys 114, a connection button (TALK) 110 above the alphanumeric keys 114, a connection indicator 111 associated with the TALK button 110, and a battery charge indicator (LOW BATT) 112. As shown in FIG. 5, handset 10 comprises a high frequency modulation circuit 12 for receiving signals from the antenna 20, a transmitter audio frequency amplification circuit 13 connected to the high frequency modulation circuit 12 for transmitting audio signals to transmitter 30, a decoder 14 connected to the high frequency modulation circuit 12, a microprocessor control unit (MCU) 15 connected to the transmitter audio frequency amplification circuit 13 and the decoder 14, an encoder 16 connected the high frequency modulation circuit 12 and the microprocessor control unit (MCU) 15, and a receiver audio frequency amplification circuit 17 connected to the high frequency modulation circuit 12 and the microprocessor control unit (MCU) 15 for receiving audio signals from receiver 40.

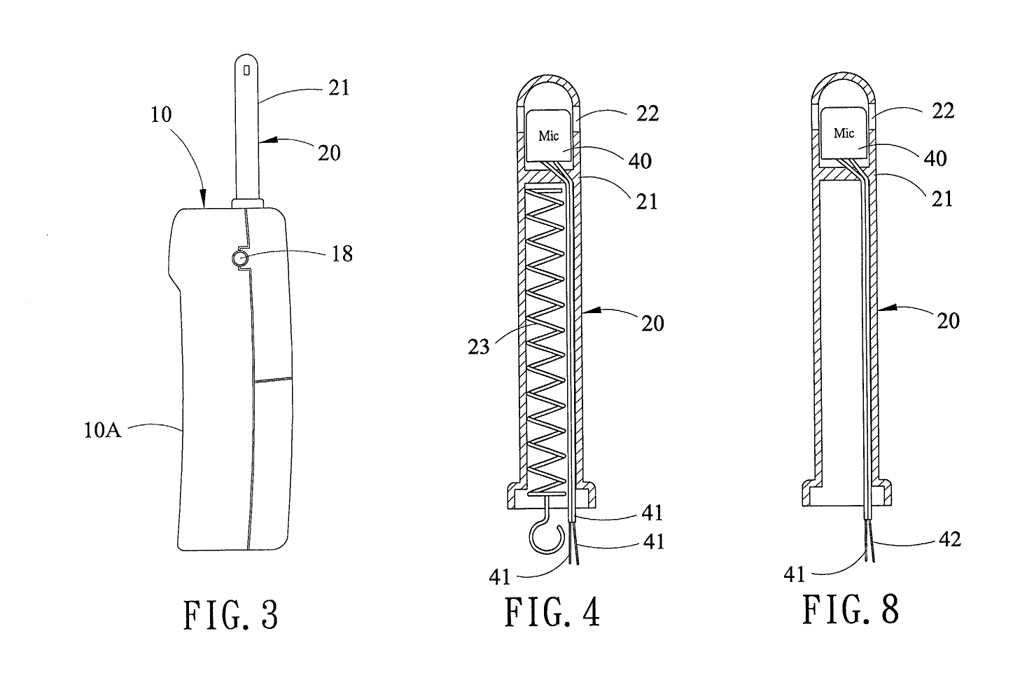

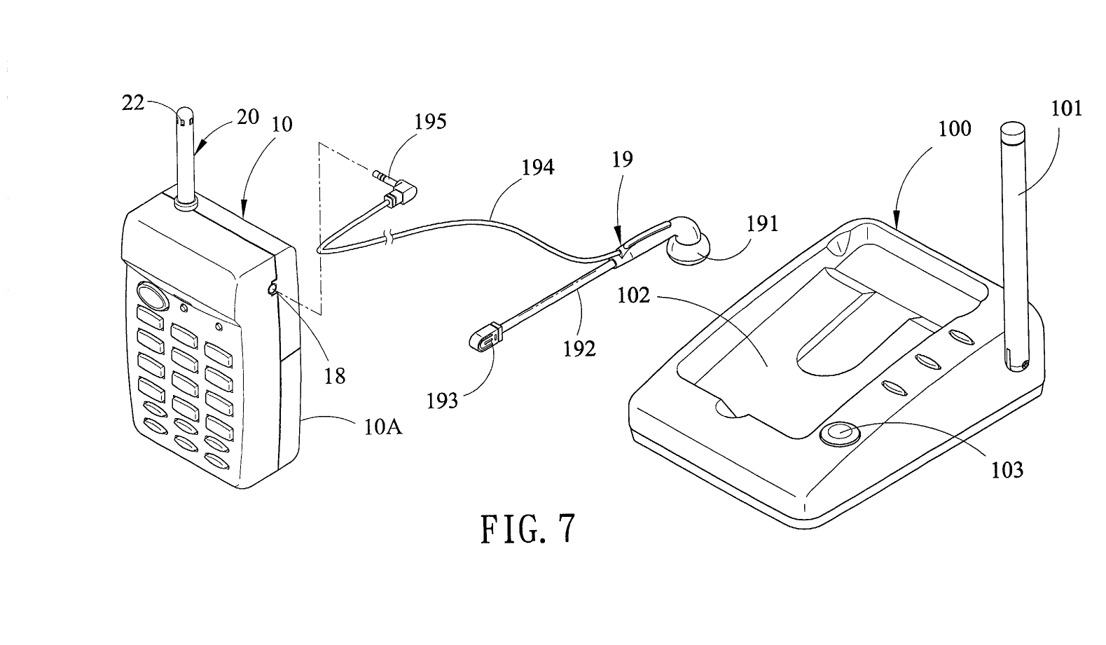

As shown in FIGS. 3 and 7, a second preferred embodiment of handset of the present invention is illustrated. On the right side of housing 10A, an earphone jack 18 is formed. Hence, a typical earphone device 19, including an earpiece 191, a bar 192, a microphone 193, a line 194, and a plug 195, may be inserted into the earphone jack 19 for electrically connecting thereto. In this embodiment, the handset is positioned in a pocket of clothing and used in hand-free manner so that it is very convenient for user. It means that user can work with two hands when receiving a phone calling. These components are well known. Thus a detailed description thereof is omitted herein for the sake of brevity.

The improvements of the invention are that (a) the height of handset 10 is reduced to be substantially the same as that of keypad 11, resulting in a reduction of size and weight of handset 10 thus enabling to be placed in a small space (e.g., pocket of clothing) for ease of calling in a hands-free manner; (b) the receiver 40 is enclosed by and provided at a predetermined location of antenna 20, preferably at the upper part (or at middle portion) of antenna 20 (FIG. 4); and (c) transmitter 30 is provided on the back of housing 10A of handset 10 for prolonging the audio feedback path between receiver 40 and transmitter 30, resulting in a substantially total elimination of audio feedback caused by the height reduction of handset 10.

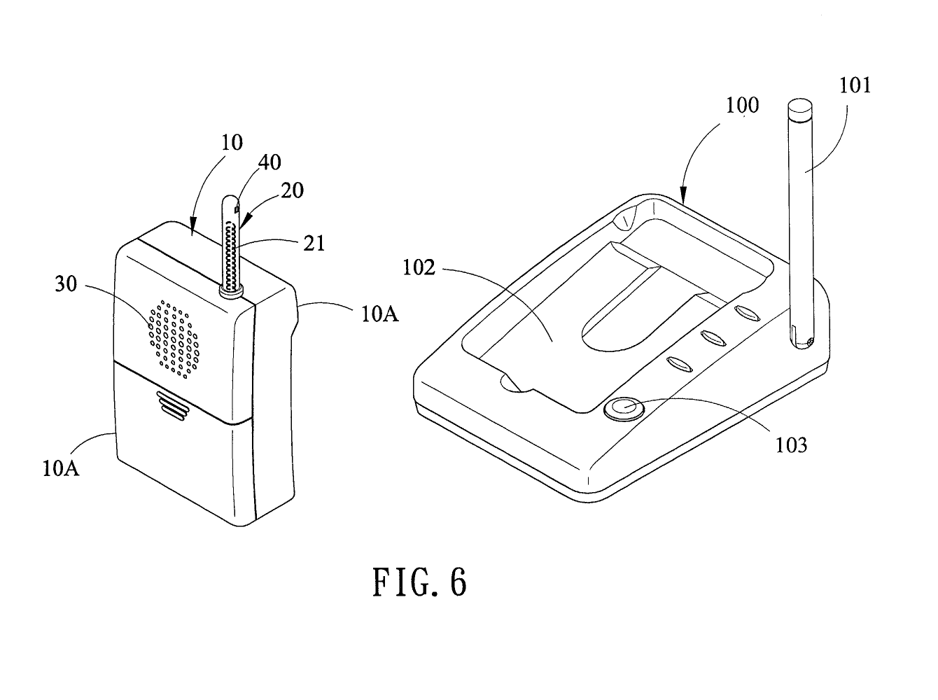

Referring to FIG. 4, antenna 20 comprises an elongate housing 21 with receiver (i.e., microphone) 40 enclosed preferably at the upper part and a hole 22 on the upper part adjacent receiver 40,and a helical antenna member 23 enclosed on the lower part of the housing. It is designed that hole 22 and transmitter 30 are preferably required to be at different side of handset 10. Thus only user's voice rather sound from transmitter 30 may be received by receiver 40 through hole 22. Two lead wires 41 are extended from receiver 40 through helical antenna 23 to couple to receiver audio frequency amplification circuit 17. As shown in FIGS. 6 and 7, handset 10 may be removed from recess 102 of cordless telephone 100 by pressing a connection button 103 to unlock handset 10. Then user may make or receive a call within a predetermined distance from the cordless telephone 100. The description of the construction of cordless telephone 100 and charging of handset 10 is omitted herein because it is well known in the art.

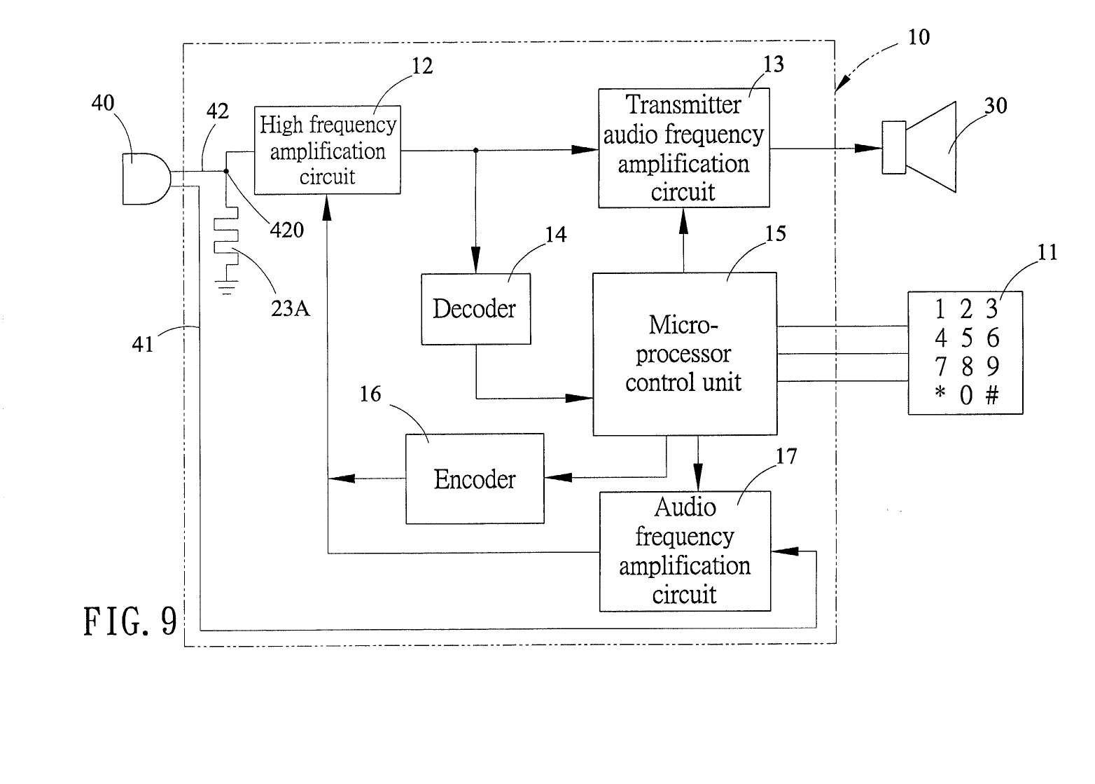

As shown in FIGS. 8-9, a third preferred embodiment of the present invention is illustrated. In this embodiment, all of the circuit components and structure are same as that of the first preferred embodiment, except that the helical antenna member 23 is omitted from the antenna 20, and one of lead wires 42 of the receiver 40 is instead to connect to a high frequency modulation circuit 12 for receiving signals and at a junction 420 a printed circuit micro strip 23A is further provided to be connected to the ground. The other lead wire 41 is also connected to a receiver audio frequency amplification circuit 17 as the first embodiment does. It will be readily appreciated that this omission may simplify the construction of the antenna member 23 and result in easily assembling for the antenna 20.

While the invention herein disclosed has been described by means of specific embodiments, numerous modifications and variations could be made thereto by those skilled in the art without departing from the scope and spirit of the invention set forth in the claims.

What is claimed is:

1. A cordless telephone having a handset comprising a housing, a circuit in said housing, an antenna on said housing, a receiver, a keypad on said front side of said housing, and a transmitter on a predetermined position of said housing, characterized in that said receiver is provided at a predetermined location of said antenna.

2. The cordless telephone of claim 1, wherein said circuit comprises a high frequency modulation circuit for receiving signals from the antenna, a transmitter audio frequency amplification circuit for transmitting audio signals to the transmitter, a decoder, a micro processor control unit, an encoder and a receiver audio frequency amplification circuit for receiving audio signals from receiver.

3. The cordless telephone of claim 2, wherein said receiver comprises a receiver audio frequency amplification circuit and further comprising two leads extended from said receiver to couple to said receiver audio frequency amplification circuit of said receiver.

4. The cordless telephone of claim 1, wherein said transmitter is on said rear side of said housing.

5. The cordless telephone of claim 1, wherein the height of said handset is substantially the same as that of said keypad.

6. The cordless telephone of claim 1, wherein said handset is removable from said cordless telephone at a predetermined distance while maintaining an electrical connection therebetween.

7. The cordless telephone of claim 2, wherein said receiver comprises a receiver audio frequency amplification circuit and further comprising a lead extended from said receiver to couple to said receiver audio frequency amplification circuit of said receiver, and an other lead being connected to said high frequency modulation circuit and at a junction of said other lead a printed circuit micro strip being connected to a ground.

8. The cordless telephone of claim 1, wherein said receiver is provided at an upper portion of said antenna.

9. The cordless telephone of claim 1, wherein said receiver is mounted on a middle portion of said antenna.
